(19) United States
(12) Patent Application Publication
(10) Pub. No.: US 2013/0314529 A1
(43) Pub. Date: Nov. 28, 2013

(54) Vessel Inspection System

(71) Applicant: James Bradley Hoffman, Austin, TX (US)

(72) Inventor: James Bradley Hoffman, Austin, TX (US)

(73) Assignee: TANKNOLOGY INC., Austin, TX (US)

(21) Appl. No.: 13/481,620

(22) Filed: May 25, 2012

(51) Int. Cl. H04N 7/18

(52) U.S. Cl. 348/82; 348/E07.085

(57) ABSTRACT

This disclosure concerns a typical inspection device of the invention. In some embodiments, the inspection device functions in a storage vessel, such as a underground fuel tank, including storage vessels that comprise an explosive mixture of gases. Also, this disclosure concerns a process for inspecting the inside of the storage vessel, in some cases creating a record of the image of the inside of the storage vessel. Invention processes do not require a step of inerting the vessel. Invention devices can operate in a vessel that has not been subjected to an inerting step.

### BACKGROUND

Inspecting the interior of underground vessels or other vessels carries with it an inherent risk. This risk is compounded when the vessel contains or has contained flammable material or other flammable liquids.

One way of inspecting the interior of the vessel is to completely empty the vessel of liquid, excavate down to a manhole cover, usually located in the side of the vessel, and sending a person inside to inspect the vessel. This method is very time-consuming and expensive. It also carries a safety risk for the inspector.

A more useful solution to inspecting the inside of the vessel is to enter the vessel with some sort of recording device and then in some cases, the entry can occur through the fill pipe into the vessel. But to use the fill pipe and avoid excavating to the manhole cover, the device must be able to fit through the sub-4-inch diameter fill pipe typically found in such vessels. And while in some cases, using such a video recording device allows the process to avoid completely emptying the vessel, the operator must still render the atmosphere inert.

In order to avoid an explosion, an operator or an inspector must render the atmosphere of the vessel inert before placing any electrical device inside of the vessel. Rendering the atmosphere inert is to transform the headspace in the tank from an atmosphere containing any mixture of vapor and oxygen into an atmosphere containing a mixture of vapor and oxygen below the mixture's explosive limit. Since accomplishing this exchange of atmosphere takes hours of flushing with an inert gas, the smaller the volume to be flushed, the faster the process completes. The operator typically renders the atmosphere in the vessel inert using a procedure similar to the following procedure:
1. Isolate product piping from tank, if possible, or use an inert gas to blow the product out of the product piping.
2. Isolate vapor recovery piping from the tank. If that is not possible, shut down the entire tank field during the inspection.
3. Plug all gas exits except the normal vent riser or pipe. If the vent pipe is not available, install a temporary vent pipe.
4. Place a grounded CO₂ hose into the headspace and introduce CO2 into bottom of empty tank
5. Verify that an accurate oxygen meter reads 21% O₂ in fresh air before and after every reading.
6. Take readings at the bottom, middle, and top of the headspace.
7. Continue flushing until all three measurements read less than 7% O₂.
8. Monitor the O₂ levels inside of the tank during the video inspection.

Once the inspection has begun, the oxygen level inside of the vessel must be continuously monitored or at least monitored every 15 minutes by measuring the oxygen level at the bottom, middle, and top of the headspace. This too, increases the time and expense of conducting the inspection.

Moreover, the requirement that the recording device fit within a sub-4-inch fill pipe presents problems, as well. Most recording devices cannot meet this requirement. One that can is a fiber-optic camera. But fiber-optic cameras have a very short focal length, which means that the fiber-optic camera must be brought much closer to the surface being inspected. Also, fiber-optic cameras have a much narrower field of vision, which means that they record a much smaller area of the interior of the vessel per unit of time then a standard scale video camera. Aside from the camera, safely inserting a light source that is bright enough to adequately illuminate the tank interior during the inspection is troublesome, as well. The main trouble again is that an adequate light source is usually too large to pass through the sub-4-inch fill tube into the interior of the tank.

What is needed is a video camera that can enter through the fill pipe of the vessel, record and inspect the interior surface of the vessel in a reasonable amount of time, and do this without employing the long inerting procedure discussed above.

### SUMMARY

The current disclosure concerns a typical inspection device of the current invention. In some embodiments, the inspection device functions in a storage vessel, such as an underground fuel tank, including storage vessels that comprise an explosive mixture of gases. Also, the current disclosure concerns a process for inspecting the inside of the storage vessel, in some cases creating a record of the image of the inside of the storage vessel. Invention processes do not require a step of inerting the vessel. Invention devices can operate in a vessel that has not been subjected to an inerting step.

In a version of the current inspection device, the inspection device comprises a control unit situated outside of the vessel, a head unit adapted to passthrough the fill pipe into the vessel, with an umbilical cord connecting between the control unit and the head unit, and a handle to manipulate the head unit. In some embodiments, the control unit comprises any one or any combination of a power supply for the device including for the head unit, various circuitry for control of energizing the head unit, de-energizing the head unit, the video camera, the video recording device or devices, the lights in the head unit, the gas flow rate or gas pressure, and de-energizing the head unit when sensors in the control unit or sensors in the head unit indicate insufficient gas flow rate or gas pressure—thus the head unit operates in a fail-safe manner.

Additionally, invention inspection devices can comprise a head unit. In use the head unit is a part of the inspection device that enters the vessel and comprises any one or any combination of a video camera, lights, gas inlet ports, mechanisms that allow remote control over where the video camera points or focuses, and gas flow rate or gas pressure sensors. Invention inspection devices employ video cameras as described below comprising any one or any combination of zoom controls, focus controls, and optics. Either or both of zoom controls and focus controls can communicate with the control unit through a wired or wireless signal pathway. In some embodiments employing a wired pathway, the wires run from the control unit to the head unit such that the function of the device causes the wires to remain inside of a substantially inert atmosphere or gas. The video camera optics have a depth of field such that the camera can focus on any region of the vessel interior to provide an image with good enough quality for a skilled inspector or engineer to use the image to accurately evaluate the condition of the vessel wall. Head unit lights provide enough illumination so that the camera can focus on any region of the vessel interior to provide an image with good enough quality for a skilled inspector or engineer to use the image to accurately evaluate the condition of the vessel wall.

Invention inspection devices can comprise an umbilical cord that connects between the head unit and the control unit. The umbilical cord comprises any one or any combination of a gas line, power cables passing through the gas line, or signal or data cables passing through the gas line. In embodiments that have power cables passing through the gas line, the electricity delivered to the head unit can serve to power the head unit. In embodiments that have signal wires passing to the gas line, the signal wires can carry control signals to the various components of the head unit and can receive video signals from the video camera.

Operationally, an invention process comprises inserting the head unit into the vessel. In some embodiments, the head unit passes through a fill pipe or other access pipe or fitting to enter the vessel. In some embodiments, the head unit has the correct dimensions to pass through the fill pipe. After the head unit is placed into the vessel, or at any time prior to entering the vessel, a flow of inert gas starts, and the gas flow enters the head unit such that all of the electrical components of the inspection device that are inside the vessel are contained in an inert atmosphere. Afterwards, the video camera is directed at the interior surface of the vessel and in some embodiments, the inspector records the video signals creating a movie of the entire inside surface of the vessel or any portion of the inside surface of the vessel that the inspector desires to view. The inspector can also display the video signals in real time on a monitor connected to the control unit or separate from the control unit. The head unit can be inserted into the vessel and safely used to record the condition of the Interior of the vessel without risk of an electrical spark causing a fire or explosion. Thus, invention processes can record the interior of the vessel without relying on the hours-long inerting process. Therefore, invention processes can be much faster than prior art processes.

### BRIEF DESCRIPTION OF THE FIGURES

FIG. 1 depicts a block diagram of an embodiment of the Vessel Inspection System.

FIG. 2 depicts a block diagram of an embodiment of the Head Unit of the Vessel Inspection System.

FIG. 3 depicts the front of an embodiment of a Head Unit of the Vessel Inspection System.

FIG. 4 depicts a block diagram of a Control Unit of the embodiments of the Vessel Inspection System.

FIG. 5 depicts the rear of the head unit of FIG. 3.

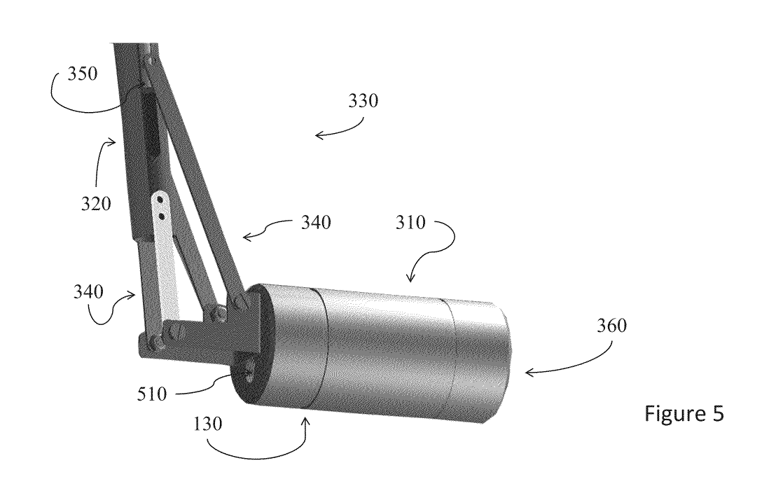

### DETAILED DESCRIPTION

The following description of several embodiments describes non-limiting examples that further illustrate the invention. All titles of sections contained herein, including those appearing above, are not to be construed as limitations on the invention, but rather they are provided to structure the illustrative description of the invention that is provided by the specification.

Unless defined otherwise, all technical and scientific terms used in this document have the same meanings as commonly understood by one skilled in the art to which the disclosed invention pertains. The singular forms “a”, “an”, and “the” include plural referents unless the context clearly indicates otherwise. Thus, for example, reference to “fluid” refers to one or more fluids, such as two or more fluids, three or more fluids, etc.

The features, aspects, and advantages of the invention will become more apparent from the following detailed description, appended claims, and accompanying drawings.

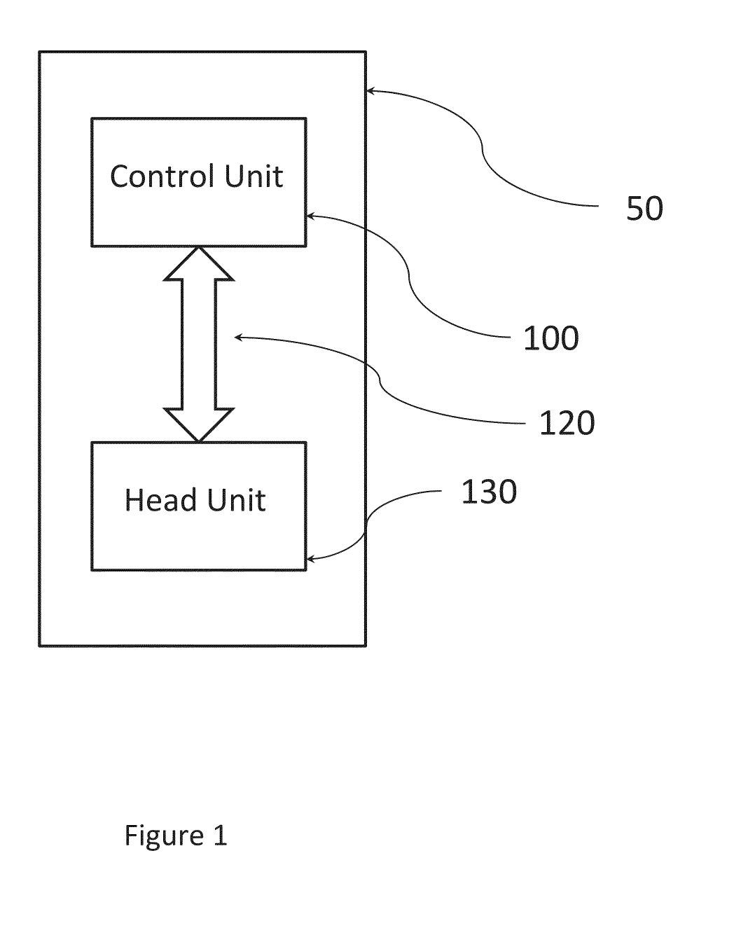

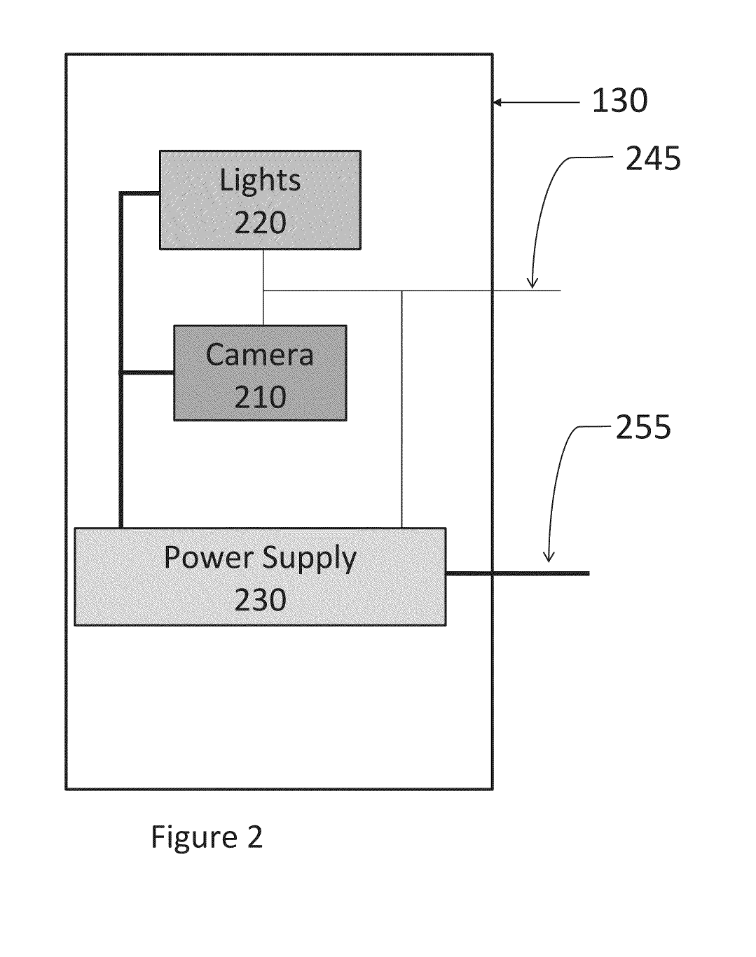

As shown in FIG. 1, device 50 of this invention comprises three major units: control unit 100, umbilical cord 120, and head unit 130. FIG. 2 shows a block diagram of head unit 130, specifically a diagram showing some of the internal components of head unit 130. Head unit 130 comprises camera 210, lights 220, and power supply 230. In some embodiments, head unit 130 may optionally contain an internal microphone (not shown). Camera 210 is sometimes referred to as a video camera.

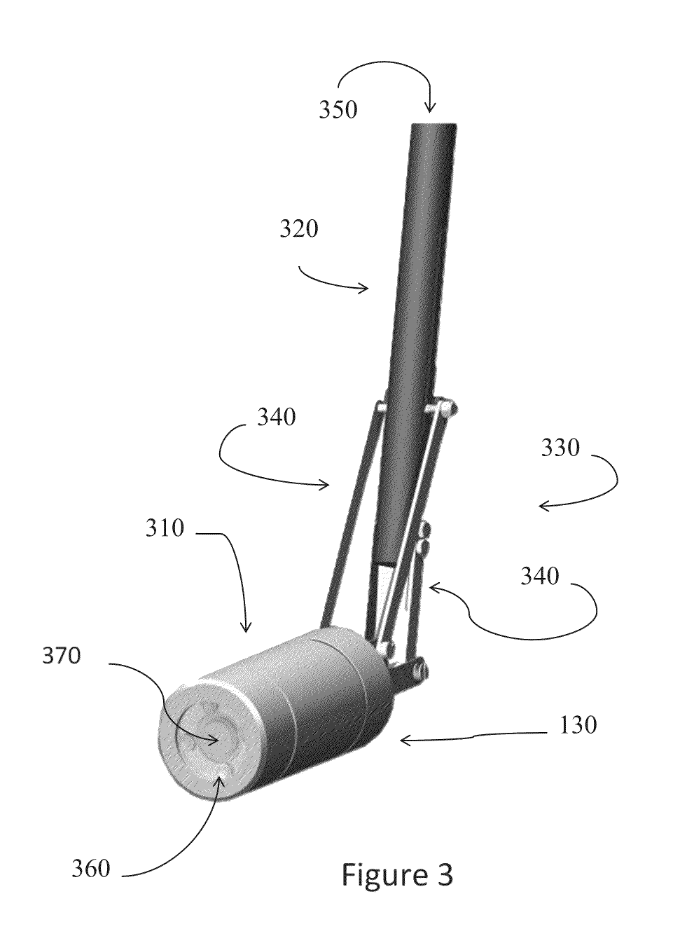

Power supply 230 provides the correct voltage required by camera 210 and lights 220. For purposes of this disclosure, “power” and “electrical power” are used interchangeably. As shown in FIG. 3, the internal components of head unit 130 are located within housing 310, which protects the internal components and which serves as a rigid member within which to physically fix the internal components of head unit 130. Additionally, housing 310 connects to and provides a passage for umbilical cord 120 to the interior of head unit 130.

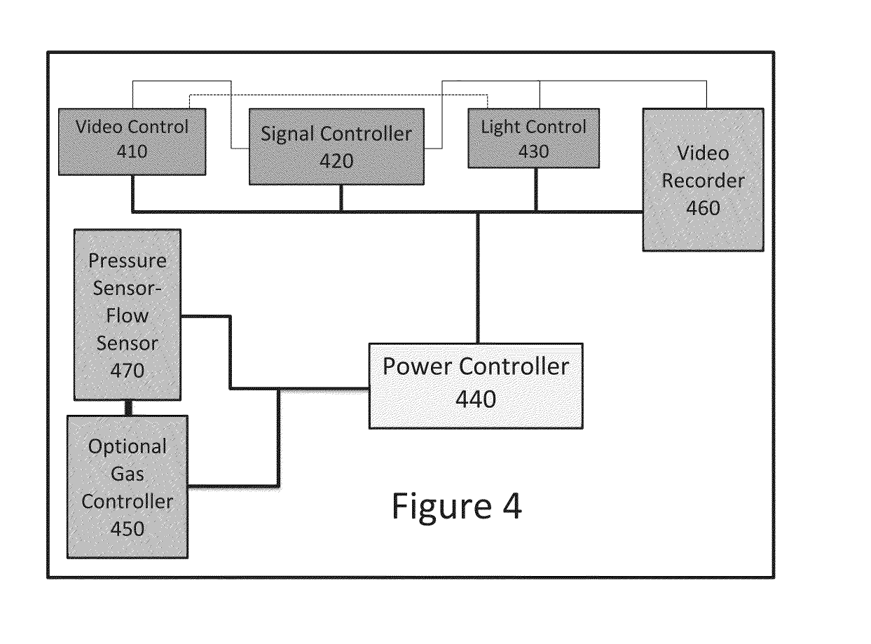

Control unit 100 is shown in FIG. 4 as a block diagram. Control unit 100 comprises video control 410, signal controller 420, light control 430, power controller 440, and optionally a gas controller 450. Additionally, control unit 100 comprises an internal video recorder 460 or a signal directing apparatus that can switch or otherwise direct the video signal from camera 210 through control unit 100 out to a device for recording the video signals from camera 210, that is, some type of external video recorder.

Device 50 optionally comprises handle 320, as shown in FIG. 3. Handle 320 mounts to head unit 130 through articulation 330. In some embodiments, articulation 330 comprises an assortment of rigid brackets 340 connecting between handle 320 and head unit 130. In some embodiments, handle 320 is a hollow tube with manipulating tube 350 disposed within handle 320 and operable in an up-and-down or back-and-forth direction. The lower end of manipulating tube 350 connects to at least one rigid bracket 340 such that the up-and-down motion translates into up-and-down motion of tip 360 of head unit 130.

Umbilical cord 120 passes power to head unit 130. In some embodiments, umbilical cord 120 passes video signals and nonflammable gas from head unit 130 to control unit 100. That is, in some embodiments, umbilical cord 120 functions as a gas line. In these or other embodiments, umbilical cord 120 functions as a signal pathway.

Head unit 130 further comprises a substantially airtight canister movably connected to handle 320 in an articulated fashion. Head unit 130 comprises camera 210, which itself comprises a lens 370 disposed such that lens 370′s field of view extends out from tip 360 of head unit 130. Head unit 130 additionally comprises lights 380 that connect to light control 430 and that are disposed around lens 370 set into or attached to tip 360. In some embodiments, camera 210 comprises optics that comprise one or more of a focusing mechanism, a zoom mechanism, and an F-stop adjustment mechanism.

In some embodiments, head unit 130 additionally comprises an internal gas cylinder. In these or other embodiments, head unit 130 connects to an external gas source. In some embodiments, head unit 130 has an overall diameter small enough to enter the fill pipe of an underground vessel. In these or other embodiments, head unit 130 has an overall dimension in its smallest dimension of less than 4, 3, 2, or 1 inches.

In some embodiments, head unit 130 additionally comprises a gas pressure sensor, a gas flow sensor, or some other sensor that functions to measure gas flow or gas pressure. The sensors connect to a normally open switch placed inside head unit 130 and designed to disrupt power should the gas stop flowing at a predefined rate or the pressure drop below a predefined level. In other embodiments, these sensors connect to signal wires leading out of the vessel or to control unit 100. Head unit 130 additionally comprises an entrance 510 for umbilical cord 120 to connect to head unit 130. In some embodiments, entrance 510 also serves as an entrance for a gas. In other embodiments, gas enters through a separate gas entrance.

Umbilical cord 120 may comprise electrical wires to power the various components contained in head unit 130. In some embodiments, umbilical cord 120 additionally comprises cables for transmitting video signals from camera 210 out of the vessel or to control unit 100. In some embodiments, umbilical cord 120 additionally comprises cables for transmitting control signals from outside the vessel or from control unit 100 into the vessel and into head unit 130. In some embodiments, these control signals carry instructions to camera 210, lights 220, or to power supply 230. Umbilical cord 120 comprises a casing that is substantially gas tight through which one or more of the electrical wires or connections pass, in some embodiments. Typically, “substantially gas tight” means that whatever amounts of gas that leak out of the casing are small enough so that, despite leakage, the gas within the casing prevents liquid or vapors from entering into the casing. While perhaps most convenient, umbilical cord 120 need not contain a single casing. In other words, umbilical cord 120 may comprise more than one casing, tube, etc.

In some embodiments in which umbilical cord 120 comprises a substantially gas tight casing, the casing serves as the conduit for gas from outside the vessel into housing 310. In some embodiments, umbilical cord 120 runs freely from control unit 100 to entrance 510. In other embodiments, umbilical cord 120 attaches to the outside of handle 320. And in some embodiments, umbilical cord 120 is further constrained by routing it down handle 320, through hollow tube and manipulating tube 350.

Control unit 100 sits outside of the vessel and connects to head unit 130 through umbilical cord 120. Control unit 100 comprises one or more of the following: video control 410, signal controller 420, gas controller 450, video recorder 460, and pressure sensor-flow sensor 470.

Video control 410 comprises hardware-software combinations that allow remote control of camera 210. Depending upon the available controls on camera 210, video control 410's hardware-software combinations can provide remote control of F-stop settings, zoom control, and focus control, etc.

Light control 430 provides control over lights 220 using hardware-software combinations that allow for remote control over the functionality of lights 220. In some embodiments, that control extends to controlling the brightness of lights 220 and turning lights 220 on or off. In some embodiments, light control 430 controls or is controlled by video control 410.

Signal controller 420 comprises hardware-software combinations that control the video signal from camera 210. Typical parameters that signal controller 420 controls include starting the video signal, stopping the video signal, displaying the video signal in real time on an optional monitor (not shown), routing the signal to a video recorder 460 integral with control unit 100, or routing the signal to an external video recorder, among other functions.

Power controller 440 controls the down-hole power to head unit 130. In some cases, power controller 440 provides a constant voltage to power supply 230 that power supply 230 modifies into whatever voltages the components of head unit 130 require. Alternatively, power supply 230 supplies the desired voltages to head unit 130. The ability to turn the power to head unit 130 on or off is contained in power controller 440.

In some embodiments, power controller 440 communicates with optional gas controller 450 or pressure-sensor-flow-sensor 470. This connection allows the power controller 440 to immediately shut off power to head unit 130 if gas pressure or gas flow ceases. Thus, it serves as a failsafe.

In some embodiments, control unit 100 further comprises a gas outlet or hose bib. In these or other embodiments, control unit 100 further comprises a gas inlet.

Handle 320 comprises a hollow tube that connects to head unit 130 through a movable connecting assembly. Handle 320 extends up through the fill tube and protrudes out of the vessel far enough so that the end extending from the vessel can manipulate head unit 130 within the vessel by manipulating handle 320 and inner tube 350 outside of the vessel. In some embodiments, the outer end of handle 320 connects to or mounts in a base situated above the fill tube to aid in steadying handle 320 and hence head unit 130. In some embodiments, the mount can be moved stepwise or continuously using a stepping motor or the mount can be moved manually. In some embodiments, the base provides the ability to incrementally move handle 320 into or out of the vessel. In some embodiments, handle 320 is hand-held.

In operation, the operator introduces head unit 130 into a vessel. At that point, the operator can manipulate handle 320, rotating it around its cylindrical axis, which in turn rotates head unit 130, as the operator desires, in the axial direction. Similarly, the operator can manipulate inner tube 350 in an up-and-down fashion, which causes tip 360 of head unit 130 to move up and down in a vertical direction.

This ability to position tip 360, lens 370 end, axially and vertically, gives the operator the ability to point head unit 130 at any interior surface of the vessel. This, combined with the ability of head unit 130 to zoom and focus on near and distant objects, allows optical inspection of the entire surface from a central point within the interior of the vessel. Similarly, camera 210 can focus through liquids remaining in the vessel.

Once the operator correctly positions head unit 130, control unit 100 operates to begin gas flow. Gas flows from the gas tank, through control unit 100, through umbilical cord 120, into head unit 130. This gas flow, in embodiments using inert gas, can leak through any openings that may be present in head unit 130. This flushes any air that was in head unit 130 out of housing 310 and replaces it with inert gas. Despite being in a potentially explosive environment, the electrical components of head unit 130 that could generate electrical sparks are in a region of gas lacking enough oxygen to reach an explosive mixture with vapor in the vessel.

Upon the gas pressure reaching a high enough value or the gas flow rate reaching a high enough value, the pressure or flow sensor in control unit 100 or in head unit 130 or in both activates, allowing the power controller 440 or power supply 230 to power up the electronics in head unit 130. Instead of or in addition to using an external gas tank or cylinder head unit 130 may contain an internal gas cylinder for flushing head unit 130 and rendering its atmosphere inert. In these or other embodiments, control signals can also depart to and arrive from control unit 100 and head unit 130 wirelessly. In these or other embodiments, the power supply for head unit 130 is a battery inside of head unit 130.

The system uses these types of procedures to insure that no electrical power reaches head unit 130 until its atmosphere has become inert. For purposes of this disclosure, inert means that all parts of umbilical cord 120 (in embodiments containing an umbilical cord 120) and head unit 130 have been flushed with inert gas such that the ratio of oxygen to vapor remaining in umbilical cord 120 and head unit 130 is below the explosive limit.

Once the gas pressure and gas flow have reached the desired level, inspection of the interior of the vessel progresses as with other inspection methods known to those of ordinary skill in the art. The head unit powers up and the operator focuses the video camera on the inside of the vessel. This video signal displays in real time on a monitor and is recorded, if desired. In some embodiments, the total amount of time needed to finish a recording of a complete vessel inner surface is 1.5, 1.2, 1.1, 1.0, 0.9, 0.8, 0.7, or 0.66 seconds per square foot of interior area.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true, intended, explained, disclose, and understood scope and spirit of this invention's multitudinous embodiments and alternative descriptions.

Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that specifically exclude the value or the conditions for the aspect.

Finally, headings are for the convenience of the reader and do not alter the meaning or content of the disclosure or the scope of the claims.

1. A process for viewing a vessel, wherein the vessel comprises a fill pipe or other access fitting and has a volume including a liquid and a headspace wherein the process comprises
supplying a device comprising a head unit, wherein the head unit includes a video camera,
manipulating the head unit into the headspace through the vessel fill pipe or other access fitting and
supplying electrical power to the head unit
wherein the vessel contains at least one region comprising a mixture of vapor and oxygen.

2. The process of claim 1 wherein the mixture of vapor and oxygen is flammable or explosive.

3. The process of claim 2 wherein the vessel liquid volume is zero.

4. The process of claim 2 wherein the vessel headspace volume is zero.

5. The process of claim 2 wherein the vessel headspace volume is non-zero and the vessel liquid volume is non-zero.

6. The process of claim 2 wherein the device further comprises
an optional gas pressure sensor or an optional gas flow sensor and a control unit situated outside of the vessel
wherein the control unit and the head unit communicate using a signal pathway that is wired or wireless.

7. The process of claim 2 wherein the control unit provides electrical power to the head unit through power cables or the head unit further comprises a battery that provides electrical power to the head unit.

8. The process of claim 6 wherein the device further comprises a gas source and the optional gas flow sensor or the optional gas pressure sensor is configured to cut power to the head unit or cut power within the head unit upon either sensor registering insufficient gas pressure or gas flow.

9. The process of claim 8 wherein both the control unit and head unit comprise a gas flow sensor or a gas pressure sensor.

10. The process of claim 8 wherein the gas source is internal to the head unit.

11. The process of claim 8 wherein the gas source is external to the head unit and connects to the head unit through a gas line.

12. The process of claim 8 wherein
the gas source is external to the head unit
the gas source connects to the control unit through a first gas line and
the control unit connects to the head unit through a second gas line.

13. The process of claim 12 wherein the power cables and the signal pathway run through the inside of the second gas line, which connects between the control unit and the head unit.

14. The process of claim 13 wherein the video camera comprises zoom and focus controls communicating with the control unit through the signal pathway.

15. The process of claim 14 wherein optics of the video camera have a depth of field such that the video camera can view substantially all of the interior surface of the vessel while being located near the fill pipe or other access fitting through which the inspection is conducted.

16. The process of claim 15 wherein the head unit further comprises
lights mounted in or on the head unit to adequately illuminate the interior surface of the vessel at least as far as the video camera optics can view and
wherein the control unit sends signals to or receives signals from the lights through the signal pathway.

17. The process of claim 16 further comprising
starting a gas flow from the gas source through the first gas line
into the control unit through an optional gas pressure sensor, an optional gas flow sensor, or both
out of the control unit through the second gas line
into the head unit through an optional gas pressure sensor, an optional gas flow sensor, or both
wherein at least one gas pressure sensor or gas flow sensor is present in the device and
wherein at least one sensor present in the device is calibrated to prevent electrical power flow to the head unit until at least one of gas flow or gas pressure is sufficient to cause the internal components of the head unit to be surrounded by an atmosphere of the gas as opposed to an atmosphere of a mixture containing oxygen within the mixture's flammable or explosive range.

18. The process of claim 17 further comprising, after starting the gas flow,
supplying electrical power to the head unit
receiving from the video camera an image signal and
automatically or manually manipulating the tip of the head unit and the video camera focus and zoom to record the image signal creating an image of the interior surface of the vessel.

19. The process of claim 18 wherein the vessel is an underground storage tank or underground fuel tank.

20. An inspection device comprising
a control unit situated outside of a vessel
a head unit adapted to pass through a fill pipe or other access fitting into the vessel
an umbilical cord connecting the control unit to the head unit and
a handle configured to control the direction that the head unit's video camera points
wherein the control unit comprises
an optional gas pressure sensor or an optional gas flow sensor
control circuitry
a power supply
and
a video recording device
wherein the head unit comprises
a video camera comprising
zoom and focus controls communicating with the control unit through the signal pathway
and
optics that have a depth of field such that the video camera can view substantially all of the interior surface of the vessel while being located near the fill pipe or other access fitting
lights mounted in or on the head unit to adequately illuminate the interior surface of the vessel at least as far as the video camera optics can view
wherein the umbilical cord comprises
a gas line
power cables passing through the lumen of the gas line routing power between the head unit and the control unit
and
signal wires passing through the lumen of the gas line routing signals between the head unit and the control unit and adapted to transmit video signals to the head unit
wherein the inspection device comprises at least one of a gas pressure sensor or a gas flow sensor configured to cut power to the head unit or to cut power within the head unit.
